(19) United States
(12) Patent Application Publication
(10) Pub. No.: US 2017/0177107 A1
(43) Pub. Date: Jun. 22, 2017

(54) Infrared Touch Screen, Touch Detection Method and Display Apparatus

(71) Applicants: BOE Technology Group Co., Ltd., Beijing (CN); Hefei Xinsheng Optoelectronics Technology Co., Ltd., Anhui (CN)

(72) Inventor: Jin Sha, Beijing (CN)

(73) Assignees: BOE Technology Group Co., Ltd., Beijing (CN); HEFEI Xinsheng Optpelectronics Technology Co., Ltd, Anhui (CN)

(21) Appl. No.: 15/300,019

(22) PCT Filed: Feb. 27, 2015
(86) PCT No.: PCT/CN2015/073347

§ 371 Date: Sep. 28, 2016

(30) Foreign Application Priority Data
Nov. 21, 2014 (CN) 201410676709.3

(51) Int. Cl. G06F 3/042

(52) U.S. Cl. CPC G06F 3/042; G06F 2203/04108; G06F 2203/04109

(57) ABSTRACT

The present disclosure provides an infrared touch screen, a touch detection method and a display apparatus. The infrared touch screen includes: a transparent panel having a touch surface; an infrared emitting device configured to emit an infrared ray which is emitted into the transparent panel and totally reflected in the transparent panel; an infrared receiving device configured to receive the totally reflected infrared ray; and a processor configured to analyze intensity of the infrared ray received by the infrared receiving device to determine touch strength.

### CROSS-REFERENCE TO RELATED APPLICATION

This application claims benefit of Chinese Patent Application No. 201410676709.3, filed with SIPO on Nov. 21, 2014, which is incorporated herein by reference in their entirety.

### BACKGROUND OF THE DISCLOSURE

Field of the Disclosure

The present disclosure relates to the technical field of display, and in particular, to an infrared touch screen, a touch detection method and a display apparatus.

Description of the Related Art

A touch display screen may be operated as long as the user's finger(s) touch(es) icons or characters on the display screen. In this way, the Human-Computer Interaction may become more direct. In these days, the touch display screen has been used widely in various applications in society lives.

Depending on work principles and information transmission medium of the touch screen, the touch screen is typically classified into four categories, i.e., resistance touch screen, capacitance sensing touch screen, infrared touch screen and surface acoustic wave touch screen. In these touch screens, the infrared touch screen may immune to current, voltage and electrostatic disturbances and be suit for bad environmental conditions, thus the infrared touch screen represents trend of development in touch screen products.

FIGS. 1-2 are schematic views showing a structure of the conventional infrared touch screen. The touch screen includes a transparent panel 10, infrared emitting devices 21 and infrared receiving devices 22. In the touch screen, the transparent panel 10 has a shape of rectangle, and includes a first side 11, a second side 12, a third side 13 and a fourth side 14. The first side 11 is arranged in opposite to the third side 13. The second side 12 is arranged in opposite to the fourth side 14. A plurality of infrared emitting devices 21 are provided on the first side 11 and the second side 12. Infrared receiving devices 22 corresponding to the infrared emitting devices 21 in one-to-one correspondence are provided on the third side 13 and the fourth side 14. The touch operations are achieved on the basis of the following principle: the infrared emitting devices 21 on the first side 11 and second side 12 arranged adjacently emit a crossed infrared matrix; when the finger(s) touch(es) the screen, as shown in FIG. 2, the finger(s) may block two crossed infrared rays passing by a touch position A when it(they) is put at the position. Thus, it may determine the position on the screen where the touch point(s) is(are) located.

### SUMMARY

An embodiment of the present application provides an infrared touch screen, a touch detection method and a display apparatus. The infrared touch screen follows a principle other than the conventional infrared touch screen principle and may be used to detect touch strength.

In view of the above, technical solutions of embodiments of the present application are provided as follows.

An embodiment of the present application provides an infrared touch screen, comprising: a transparent panel having a touch surface; an infrared emitting device configured to emit an infrared ray which is emitted into the transparent panel and totally reflected in the transparent panel; an infrared receiving device configured to receive the totally reflected infrared ray; and a processor configured to analyze intensity of the infrared ray received by the infrared receiving device to determine touch strength.

In an embodiment, the infrared touch screen comprises: an infrared emitting device configured to emit a plurality of infrared rays into the transparent panel; and a plurality of the infrared receiving devices configured to receive the plurality of infrared rays emitted by the infrared emitting device respectively.

In an embodiment, the transparent panel is in a shape of rectangle, and the infrared emitting device emits the plurality of infrared rays from a corner of the transparent panel and the plurality of infrared rays propagate towards a plurality of positions at periphery of the transparent panel along respective directions in the transparent panel respectively.

In an embodiment, the plurality of infrared receiving devices are arranged at the plurality of positions at the periphery of the transparent panel respectively.

In an embodiment, the infrared emitting device has an emitting angle greater than or equal to 90° in the transparent panel.

In an embodiment, the transparent panel is in a shape of rectangle, and comprises a first side and a third side opposed to each other and a second side and a fourth side opposed to each other, and wherein the first side of the transparent panel is provided with a plurality of infrared emitting devices and the third side of the transparent panel is provided with a plurality of infrared receiving devices corresponding to the infrared emitting devices in one-to-one correspondence; and wherein the infrared rays emitted by the plurality of infrared emitting devices on the first side are emitted into the transparent panel; and the plurality of infrared receiving devices on the third side receive the infrared rays emitted by the corresponding infrared emitting devices.

In an embodiment, each of the plurality of infrared emitting devices on the first side emits the infrared ray only in one direction.

In an embodiment, the second side of the transparent panel is provided with a plurality of infrared emitting devices and the fourth side of the transparent panel is provided with a plurality of infrared receiving devices corresponding to the infrared emitting devices in one-to-one correspondence; and wherein the infrared rays emitted by the plurality of infrared emitting devices on the second side are emitted into the transparent panel; the plurality of infrared receiving devices on the fourth side receive the infrared rays emitted by the corresponding infrared emitting devices; and the processor is also configured to determine a touch position.

In an embodiment, each of the plurality of infrared emitting devices on the second side emits the infrared ray only in one direction.

In an embodiment, the transparent panel comprises an upper surface, a low surface in opposite to the upper surface and lateral surfaces located between the upper surface and the lower surface, wherein the infrared emitting device(s) and the infrared receiving device(s) are arranged on the upper surface and/or the lower surface of the transparent panel, or the infrared emitting device(s) and the infrared receiving device(s) are arranged on the lateral surfaces of the transparent panel.

Another embodiment of the present application also provides a display apparatus comprising the infrared touch screen as described in any one of the above embodiments.

In an embodiment, the display apparatus further includes an upper substrate and a lower substrate opposed to each other, wherein the upper substrate comprises a base substrate and a display structure formed on the base substrate, and the base substrate is the transparent panel, and the infrared rays emitted by the infrared emitting device(s) are emitted into the base substrate and totally reflected in the base substrate.

In an embodiment, the display apparatus is a liquid crystal display apparatus or an organic light emitting diode display apparatus.

A further embodiment of the present application also provides a touch detection method used in the infrared touch screen as described in any one of the above embodiments, the method comprising: emitting infrared rays into the transparent panel by the infrared emitting device(s) and causing the infrared rays to be totally reflected in the transparent panel; receiving the totally reflected infrared rays by the infrared receiving device(s); and analyzing intensity of the infrared rays received by the infrared receiving device(s) by the processor to determine a touch strength.

Embodiments of the present application provide an infrared touch screen, a touch detection method and a display apparatus. The infrared touch screen includes a transparent panel, an infrared emitting device, an infrared receiving device and a processor. The infrared rays emitted by the infrared emitting device are totally reflected in the transparent panel. When a finger touches the surface of the transparent panel of the infrared touch screen, the infrared rays enters an optical denser medium from an optically thinner medium at the touch position of the finger and is refracted at the touch position and part of the infrared rays at this position are absorbed by the finger. On one hand, the larger the touch strength of the finger is (i.e., the larger the applied force is), the larger the contact area between the finger and the transparent panel is and the more the infrared light absorbed by the finger becomes. On the other hand, the infrared rays are very sensitive to a medium interface at which the infrared rays are totally reflected or refracted on the surface of the transparent panel, thus the larger the touch strength of the finger is, the tighter the finger contacts with the transparent panel and the less the air between the finger and the transparent panel becomes and the more the infrared rays absorbed at the touch position become. The infrared rays are totally reflected at other positions and are not absorbed. The processor may further determine the amount of reduction of the infrared rays received by the infrared receiving device depending on the intensity of the infrared rays received by the corresponding infrared receiving device, and thus may determine the touch strength.

### BRIEF DESCRIPTION OF THE DRAWINGS

In order to explain technical solutions of embodiments of the present application or the prior art more clearly, the drawings that are used to illustrate the embodiments or the prior art will below be described briefly. Apparently, the drawings described below only show some of embodiments of the present application, instead of limiting the present application.

FIG. 1 is a schematic view showing the conventional infrared touch screen;

FIG. 2 is a schematic top view showing a structure of the infrared touch screen shown in FIG. 1;

FIG. 3 is a schematic view showing an infrared touch screen provided by an embodiment of the present application;

FIG. 4 is a schematic view showing another infrared touch screen provided by an embodiment of the present application;

FIG. 5 is a schematic side view showing a structure of the infrared touch screen shown in FIG. 4;

FIG. 6 is a schematic view showing another infrared touch screen provided by an embodiment of the present application;

FIG. 7 is a schematic view showing a display apparatus provided by an embodiment of the present application;

FIG. 8 is a schematic view showing another display apparatus provided by an embodiment of the present application;

FIG. 9 is a flow chart of a touch detection method provided by an embodiment of the present application.

### REFERENCE NUMERALS

10 Transparent Panel; 11 First Side; 12 Second Side; 13 Third Side; 14 Fourth Side; 21 Infrared Emitting Device; 22 Infrared Receiving Device; 23 Processor; 30 Finger; 100 Liquid Crystal Display Screen; 40 Upper Substrate; 50 Liquid Crystal; 60 Lower Substrate.

### DETAILED DESCRIPTION OF EMBODIMENTS

Below, the technical solutions of the embodiments of the present application will be described clearly and completely with reference to accompanied figures. Apparently, the described embodiments are only part of embodiments of the present application, instead of all of embodiments. All of other embodiments that the skilled person in the art obtains from these embodiments of the present application without creative efforts will fall within the protection scope of the present application.

In accordance with a general concept of the present application, it provides an infrared touch screen, comprising: a transparent panel having a touch surface; an infrared emitting device configured to emit an infrared ray which is emitted into the transparent panel and totally reflected in the transparent panel; an infrared receiving device configured to receive the totally reflected infrared ray; and a processor configured to analyze intensity of the infrared ray received by the infrared receiving device to determine touch strength.

In addition, for the purpose of explanation, numerous specific details are set forth in the following detailed description to provide a thorough understanding to the embodiments of the present invention. It is obvious, however, that one or more embodiments can also be implemented without these specific details. In other instances, well-known structures and devices are shown in an illustrative manner so as to simplify the drawings.

An embodiment of the present application provides an infrared touch screen. As shown in FIGS. 3-6, it includes: a transparent panel 10, an infrared emitting device 21, an infrared receiving device 22 and a processor 23. The transparent panel 10 has a touch surface 101 (for example for finger(s)'s touch). The infrared emitting device 21 is configured to emit an infrared ray. As illustrated in FIG. 5, the infrared rays emitted by the infrared emitting device 21 are totally reflected in the transparent panel 10. The infrared receiving device 22 is configured to receive the totally reflected infrared ray. The processor 23 is configured to analyze intensity of the infrared ray received by the infrared receiving device 22 to determine touch strength.

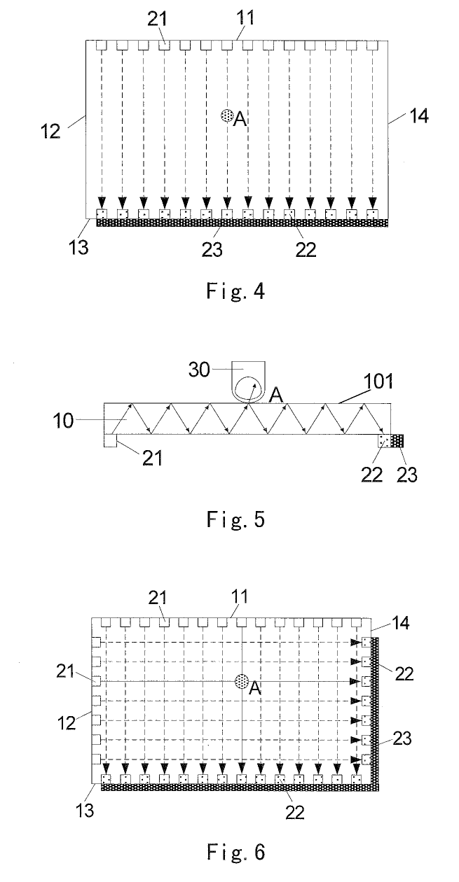

In particular, as shown in FIGS. 4-5, as an example, the touch position of the finger is indicated by A. The finger is an optically denser medium compared to the transparent panel while the air is an optically thinner medium compared to the transparent panel. Thus, the infrared ray enters the optical denser medium from the optically thinner medium at the touch position of the finger and is refracted at a position A and part of the infrared ray at this position is absorbed by the finger. On one hand, the larger the touch strength of the finger is (i.e., the larger the applied force is), the larger the contact area between the finger and the transparent panel is and the more the infrared light absorbed by the finger becomes. On the other hand, the infrared rays are very sensitive to a medium interface at which the infrared rays are totally reflected or refracted at the surface of the transparent panel, thus the larger the touch strength of the finger is, the tighter the finger contacts with the transparent panel and the less the air between the finger and the transparent panel becomes and the more the infrared rays absorbed at the touch position become. The infrared rays are totally reflected at other positions and are not absorbed. The processor may further determine the amount of reduction of the infrared rays received by the infrared receiving device depending on the intensity of the infrared rays received by the corresponding infrared receiving device, and thus may determine the touch strength.

As an example, as illustrated in FIG. 3, the infrared touch screen provided by an embodiment of the present application comprises: an infrared emitting device 21 configured to emit a plurality of infrared rays into the transparent panel; and a plurality of infrared receiving devices 22 configured to receive the plurality of infrared rays emitted by the infrared emitting device 21 respectively. As an example, the plurality of infrared rays emitted by the infrared emitting device 21 may propagate along the respective different directions.

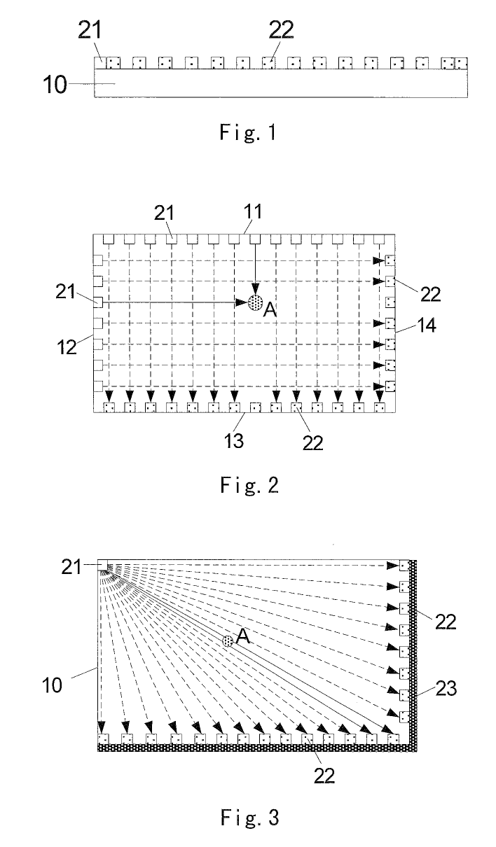

The infrared touch screen provided by the embodiment of the present application may be used separately or in combination with the conventional touch screen. For example, the infrared touch screen shown in FIGS. 3-4 according to the embodiments of the present application may be provided on the conventional touch screen (as shown in FIGS. 1-2). The touch strength may be determined by the infrared touch screen provided by the embodiment of the present application and then the touch position may be determined by the conventional touch screen.

As an example, as illustrated in FIG. 3, the transparent panel 10 is in a shape of rectangle. The infrared emitting device 21 emits the plurality of infrared rays from a corner of the transparent panel 10 and the plurality of infrared rays propagate towards a plurality of positions at periphery of the transparent panel 10 along respective directions in the transparent panel 10 respectively. As an example, the plurality of infrared receiving devices may be arranged at the plurality of positions at the periphery of the transparent panel respectively. In FIG. 3, the plurality of infrared receiving devices 22 are distributed on two sides opposed to the infrared emitting device 21 (i.e., the right hand side and the bottom side in FIG. 3), to receive the infrared rays emitted from the infrared emitting device 21. In an example, the infrared emitting device 21 may also be located at any position at the periphery of the transparent panel (for example, located on any side of the rectangular transparent panel). The infrared emitting device 21 located at the corner may achieve larger cover area of the infrared rays and may facilitate detecting the touch strength at various positions.

As an example, as illustrated in FIG. 3, the infrared emitting device 21 emits the plurality of infrared rays from the corner of the transparent panel 10. The infrared emitting device 21 has an emitting angle greater than or equal to 90° in the transparent panel. In this way, the infrared rays emitted by the infrared emitting device 21 can cover an entire transparent panel fully, thus it may detect the touch strength at any positions on the transparent panel.

In an example, as illustrated in FIG. 4, the transparent panel is in a shape of rectangle, and comprises a first side 11 and a third side 13 opposed to each other, and a second side 12 and a fourth side 14 opposed to each other. The first side 11 of the transparent panel 10 is provided with a plurality of infrared emitting devices 21 and the third side 13 of the transparent panel 10 is provided with a plurality of infrared receiving devices 22 corresponding to the infrared emitting devices 21 in one-to-one correspondence. The infrared rays emitted by the plurality of infrared emitting devices 21 on the first side 11 are emitted into the transparent panel 10. The plurality of infrared receiving devices 22 on the third side 13 receive the infrared rays emitted by the corresponding infrared emitting devices 21. As an example, each of the plurality of infrared emitting devices on the first side emits the infrared ray only in one direction. That is, one infrared emitting device emits only one infrared ray and the corresponding infrared receiving device receives only one infrared ray. Thus, the infrared rays may be distributed uniformly on the transparent panel, to detect the touch strength at the touch position.

In an example, as illustrated in FIG. 6, the transparent panel includes a first side 11 and a third side 13 opposed to each other, and a second side 12 and a fourth side 14 opposed to each other. The first side 11 and the second side 12 are provided with a plurality of infrared emitting devices 21, and the third side 13 and the fourth side 14 are provided with a plurality of infrared receiving devices 22 corresponding to the infrared emitting devices 21 in one-to-one correspondence. The infrared rays emitted by the plurality of infrared emitting devices 21 on the first side 11 and on the second side 12 are directed into the transparent panel 10. The plurality of infrared receiving devices 22 on the third side 13 and on the fourth side 14 receive the infrared rays emitted by the corresponding infrared emitting devices 21. The processor 23 analyzes the intensity of the infrared rays received by the infrared receiving devices 22 and may determine the touch position.

In an example, as illustrated in FIG. 6, the infrared rays are crossed transversely and longitudinally and the touch position is indicated by A. In this way, two infrared rays at the touch position A are absorbed and the infrared rays received by the corresponding two infrared receiving devices are weak. Thus, the touch position A may be determined from the infrared receiving devices to further achieve touch detection function. The infrared touch screen shown in FIG. 6 not only may determine the touch strength, but also may determine the touch position. It may be used to substitute the conventional touch screen.

As an example, each of the plurality of infrared emitting devices on the second side emits the infrared rays only in one direction.

In an example, the transparent panel may include an upper surface, a low surface in opposite to the upper surface and lateral surfaces located between the upper surface and the lower surface (for example, the first side, the second side, the third side, the fourth side). The infrared emitting device(s) and the infrared receiving device(s) may be arranged on the upper surface and/or the lower surface of the transparent panel, or the infrared emitting device(s) and the infrared receiving device(s) may be arranged on the lateral surfaces of the transparent panel. In an example, as shown in FIG. 5, the embodiment of the present application is explained only with reference to the case that the infrared emitting device(s) 21 and the infrared receiving devices 22 are both located on the lower surface of the transparent panel 10 (i.e., the bottom surface shown in FIG. 5).

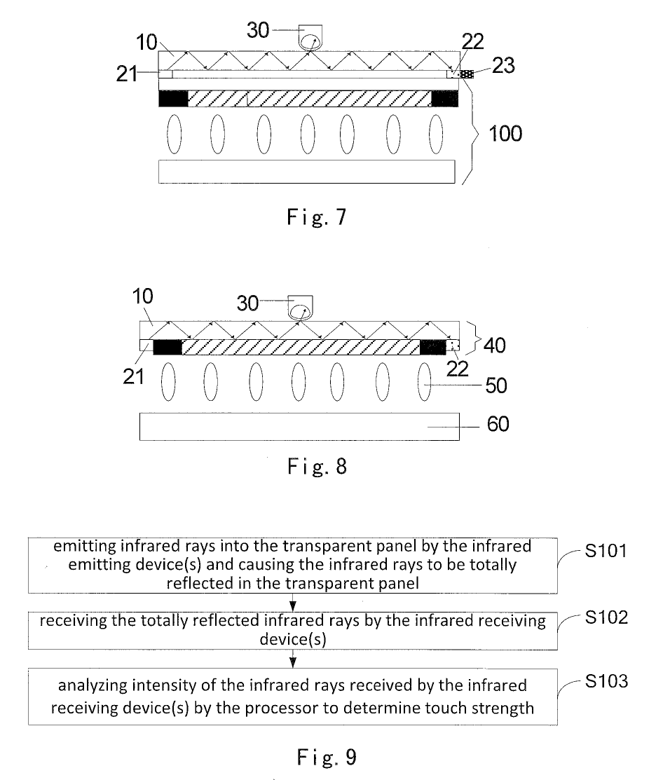

An embodiment of the present application also provides a display apparatus including the infrared touch screen described in any one of the above embodiments. Certainly, the display apparatus may also be a liquid crystal display apparatus or an organic light emitting diode display apparatus. The embodiment and the accompanying drawings of the present application are given with reference to the example of liquid crystal display apparatus. In particular, as shown in FIG. 7, the display apparatus may include a liquid crystal display screen 100 and the infrared touch screen. The display apparatus may be display devices such as liquid crystal display, electronic paper, OLED (organic light emitting diode) display, and any products or parts having the display function such as televisions, digital cameras, cell phones, or tablet computers, including the above display devices.

As an example, as illustrated in FIG. 8, the display apparatus further includes an upper substrate 40 and a lower substrate 30 opposed to each other. The upper substrate 40 comprises a base substrate and a display structure formed on the base substrate, for example, lamination layers for display. The base substrate is the transparent panel 10, and the infrared rays emitted by the infrared emitting device(s) 21 are emitted into the base substrate and totally reflected in the base substrate. Taking the liquid crystal display apparatus shown in FIG. 8 as an example, the display apparatus further includes liquid crystal 50 located between the upper substrate and the lower substrate, for example, the upper substrate 40 may be a color filter substrate and the lower substrate may be an array substrate. The upper substrate includes the transparent panel 10 and color filter layers and black matrix layers formed on the transparent panel 10, and the like. In this example, the transparent panel 10 may be a base substrate with the color filter layers and the infrared rays emitted by the infrared emitting devices 21 are totally reflected in the transparent panel 10. It contributes to reduction of the weight and thickness of the display apparatus.

It should be noted that the total reflection of the infrared rays in the transparent panel occurs when the infrared rays are incident on the optically thinner medium (e.g., the air) from the optically denser medium (e.g., glass substrate), and if the transparent panel is also formed with other display layer arrangement thereon, the display layer arrangements are optically denser medium compared to the transparent panel, such that the infrared rays emitted by the infrared emitting devices may still be totally reflected in the transparent panel.

An embodiment of the present application also provides a touch detection method used in the infrared touch screen as described in any one of the above embodiments of the present application. As illustrated in FIG. 9, the touch detection method includes:

Step 101 of emitting infrared rays into the transparent panel by the infrared emitting device(s) and causing the infrared rays to be totally reflected in the transparent panel (for example, may ensure the total reflection by adjusting the emitting angle of the infrared rays to cause the incident angle of the infrared rays at the interface between the transparent panel and the air to meet the total reflection condition);

Step 102 of receiving the totally reflected infrared rays by the infrared receiving device(s); and

Step 103 of analyzing intensity of the infrared rays received by the infrared receiving device(s) by the processor to determine touch strength.

In an example, as shown in FIG. 3, the infrared touch screen comprises: an infrared emitting device 21 configured to emit a plurality of infrared rays propagating along various directions respectively; and a plurality of infrared receiving devices 22 configured to receive the plurality of infrared rays emitted by the infrared emitting device 21. As an example, as illustrated in FIG. 3, the transparent panel 10 is in a shape of rectangle. The above step 101 may include: emitting the plurality of infrared rays which propagate along various directions respectively from a corner of the transparent panel 10 by the infrared emitting device 21. The plurality of infrared receiving devices 22 are distributed on two sides opposed to the infrared emitting device 21. The above step 102 may include: receiving the plurality of infrared rays emitted from the infrared emitting device 21 by using a plurality of infrared receiving devices 22 respectively.

In an example, as illustrated in FIG. 4, the transparent panel 10 is in a shape of rectangle, and comprises a first side 11 and a third side 13 opposed to each other, and a second side 12 and a fourth side 14 opposed to each other. The first side 11 of the transparent panel 10 is provided with a plurality of infrared emitting devices 21 and the third side 13 of the transparent panel 10 is provided with a plurality of infrared receiving devices 22 corresponding to the infrared emitting devices 21 in one-to-one correspondence. The infrared rays emitted by the plurality of infrared emitting devices 21 on the first side 11 propagate along one direction. The above step 101 may include: emitting the infrared rays into the transparent panel 10 by the plurality of infrared emitting devices 21 on the first side 11. The above step 102 may include: receiving the infrared rays emitted by the corresponding infrared emitting devices 21 by the plurality of infrared receiving devices 22 on the third side 13. That is, one infrared emitting device emits only one infrared ray (propagates along one direction) and the corresponding infrared receiving device receives only one infrared ray. Thus, the infrared rays may be distributed uniformly on the transparent panel, to detect the touch strength at the touch position.

In an example, as illustrated in FIG. 6, the first side 11 and the second side 12 of the transparent panel 10 are provided with a plurality of infrared emitting devices 21, and the third side 13 and the fourth side 14 of the transparent panel 10 are provided with a plurality of infrared receiving devices 22 corresponding to the infrared emitting devices 21 in one-to-one correspondence. The plurality of infrared emitting devices 21 on the first side 11 and on the second side 12 emit the infrared rays propagating along one direction. The above step 101 may include: emitting the infrared rays into the transparent panel 10 by the plurality of infrared emitting devices 21 on the first side 11 and on the second side 12. The above step 102 may include: receiving the infrared rays emitted by the corresponding infrared emitting devices 21 by using the plurality of infrared receiving devices 22 on the third side 13 and on the fourth side 14. The processor 23 not only may determine the touch strength, but also may determine the touch position.

The above embodiments are only examples of the present application, but the protection range of the present application is not limited to this. It would be appreciated by those skilled in the art that various modifications or alternations of the above embodiments within the scope of the present disclosure will also fall within the scope of the present application. The scope of the present application is defined by the appended claims.

1. An infrared touch screen, comprising:
a transparent panel having a touch surface;
an infrared emitting device configured to emit an infrared ray which is emitted into the transparent panel and is totally reflected in the transparent panel;
an infrared receiving device configured to receive the totally reflected infrared ray; and
a processor configured to analyze intensity of the infrared ray received by the infrared receiving device to determine touch strength.

2. The infrared touch screen according to claim 1, wherein the infrared touch screen comprises:
an infrared emitting device configured to emit a plurality of infrared rays into the transparent panel; and
a plurality of infrared receiving devices configured to receive the plurality of infrared rays emitted by the infrared emitting device respectively.

3. The infrared touch screen according to claim 2, wherein the transparent panel is in a shape of rectangle, and the infrared emitting device emits the plurality of infrared rays from a corner of the transparent panel and the plurality of infrared rays propagate towards a plurality of positions at periphery of the transparent panel along respective directions in the transparent panel respectively.

4. The infrared touch screen according to claim 3, wherein the plurality of infrared receiving devices are arranged at the plurality of positions at the periphery of the transparent panel respectively.

5. The infrared touch screen according to claim 3, wherein the infrared emitting device has an emitting angle greater than or equal to 90° in the transparent panel such that the infrared emitting device has an emitting range covering the entire transparent panel.

6. The infrared touch screen according to claim 1, wherein the transparent panel is in a shape of rectangle, and comprises a first side and a third side opposed to each other, and a second side and a fourth side opposed to each other, and wherein the first side of the transparent panel is provided with a plurality of infrared emitting devices and the third side of the transparent panel is provided with a plurality of infrared receiving devices, and each of the plurality of infrared receiving devices is configured to receive the infrared ray from one of the plurality of infrared emitting devices; and
wherein the infrared rays emitted by the plurality of infrared emitting devices on the first side are emitted into the transparent panel; and
the plurality of infrared receiving devices on the third side receive the infrared rays emitted by the respective infrared emitting devices.

7. The infrared touch screen according to claim 6, wherein each of the plurality of infrared emitting devices on the first side emits the infrared ray only in one direction.

8. The infrared touch screen according to claim 6 or 7, wherein the second side of the transparent panel is provided with a plurality of infrared emitting devices and the fourth side of the transparent panel is provided with a plurality of infrared receiving devices, and each of the plurality of infrared receiving devices is configured to receive the infrared ray from one of the plurality of infrared emitting devices on the second side of the transparent panel; and
wherein the infrared rays emitted by the plurality of infrared emitting devices on the second side are emitted into the transparent panel;
the plurality of infrared receiving devices on the fourth side receive the infrared rays emitted by the respective infrared emitting devices on the second side of the transparent panel; and
the processor is also configured to determine a touch position.

9. The infrared touch screen according to claim 8, wherein each of the plurality of infrared emitting devices on the second side emits the infrared ray only in one direction.

10. The infrared touch screen according to claim 1, wherein the transparent panel comprises an upper surface, a low surface in opposite to the upper surface and lateral surfaces located between the upper surface and the lower surface, wherein the infrared emitting device/devices and the infrared receiving device/devices are arranged on the upper surface and/or the lower surface of the transparent panel, or the infrared emitting device/devices and the infrared receiving device/devices are arranged on the lateral surfaces of the transparent panel.

11. A display apparatus comprising the infrared touch screen according to claim 1.

12. The display apparatus according to claim 11, further comprising an upper substrate and a lower substrate opposed to each other, wherein the upper substrate comprises a base substrate and a display structure formed on the base substrate, and the base substrate is the transparent panel, and the infrared rays emitted by the infrared emitting device(s) are emitted into the base substrate and are totally reflected in the base substrate.

13. The display apparatus according to claim 11, wherein the display apparatus is a liquid crystal display apparatus or an organic light emitting diode display apparatus.

14. A touch detection method used in the infrared touch screen according to claim 1, the method comprising:
emitting infrared rays into the transparent panel by the infrared emitting device(s) and causing the infrared rays to be totally reflected in the transparent panel;
receiving the totally reflected infrared rays by the infrared receiving device(s); and
analyzing intensity of the infrared rays received by the infrared receiving device(s) by the processor to determine touch strength.

15. The infrared touch screen according to claim 4, wherein the infrared emitting device has an emitting angle greater than or equal to 90° in the transparent panel such that the infrared emitting device has an emitting range covering the entire transparent panel.

16. The infrared touch screen according to claim 7, wherein the second side of the transparent panel is provided with a plurality of infrared emitting devices and the fourth side of the transparent panel is provided with a plurality of infrared receiving devices, and each of the plurality of infrared receiving devices is configured to receive the infrared ray from one of the plurality of infrared emitting devices on the second side of the transparent panel; and
wherein the infrared rays emitted by the plurality of infrared emitting devices on the second side are emitted into the transparent panel;
the plurality of infrared receiving devices on the fourth side receive the infrared rays emitted by the respective infrared emitting devices on the second side of the transparent panel; and
the processor is also configured to determine a touch position.

17. The infrared touch screen according to claim 16, wherein each of the plurality of infrared emitting devices on the second side emits the infrared ray only in one direction.

18. The infrared touch screen according to claim 2, wherein the transparent panel comprises an upper surface, a low surface in opposite to the upper surface and lateral surfaces located between the upper surface and the lower surface, wherein the infrared emitting device/devices and the infrared receiving device/devices are arranged on the upper surface and/or the lower surface of the transparent panel, or the infrared emitting device/devices and the infrared receiving device/devices are arranged on the lateral surfaces of the transparent panel.

19. The infrared touch screen according to claim 3, wherein the transparent panel comprises an upper surface, a low surface in opposite to the upper surface and lateral surfaces located between the upper surface and the lower surface, wherein the infrared emitting device/devices and the infrared receiving device/devices are arranged on the upper surface and/or the lower surface of the transparent panel, or the infrared emitting device/devices and the infrared receiving device/devices are arranged on the lateral surfaces of the transparent panel.

20. The infrared touch screen according to claim 4, wherein the transparent panel comprises an upper surface, a low surface in opposite to the upper surface and lateral surfaces located between the upper surface and the lower surface, wherein the infrared emitting device/devices and the infrared receiving device/devices are arranged on the upper surface and/or the lower surface of the transparent panel, or the infrared emitting device/devices and the infrared receiving device/devices are arranged on the lateral surfaces of the transparent panel.
